(19) United States
(12) Patent Application Publication
(10) Pub. No.: US 2007/0215423 A1
(43) Pub. Date: Sep. 20, 2007

(54) Dual Mass Linear Mass Damper

(75) Inventors: Eric D. Staley, Grand Blanc, MI (US); Edson F. Lopes, Ann Arbor, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: FREUDENBERG-NOK GENERAL PARTNERSHIP, Plymouth, MI (US)

(21) Appl. No.: 11/678,274

(22) Filed: Feb. 23, 2007

Related U.S. Application Data
(60) Provisional application No. 60/783,145, filed on Mar. 16, 2006.

(51) Int. Cl. F16F 7/10

(52) U.S. Cl. 188/379

(57) ABSTRACT

A damper is provided including first and second mass elements and first and second sets of elastic elements. The first mass element is coupled to the second mass element by the first set of elastic elements. The second mass element is coupled to a mounting structure by the second set of elastic elements.

### CROSS-REFERENCE TO RELATED APPLICATIONS

This application claims the benefit of U.S. Provisional Application No. 60/783,145, filed on Mar. 16, 2006, the disclosure of which is incorporated herein by reference.

### FIELD

The present disclosure relates to dampers, and more specifically to dual mass dampers.

### BACKGROUND AND SUMMARY

According to the present disclosure, a damper is provided including first and second mass elements and first and second sets of elastic elements. The first mass element is coupled to the second mass element by the first set of elastic elements. The second mass element is coupled to a mounting structure by the second set of elastic elements.

This present disclosure allows for a multi-directional damper to be attached to the vibration structure with one mounting scheme. This is compared to a damper of a single mass that acts in the targeted directions attached with an auxiliary surface such as, but not limited to, a stamped bracket or a multi-mass damper that is attached with multiple attachment points.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a damper according to the present disclosure;

FIG. 2 is a section view of the damper of FIG. 1 taken at line 2-2;

FIG. 3 is a section view of the damper of FIG. 1 taken at line 3-3; and

FIG. 4 is a schematic view of a mass spring system in accordance with the present disclosure.

### DETAILED DESCRIPTION

The following description is merely exemplary in nature and is not intended to limit the present disclosure, application, or uses.

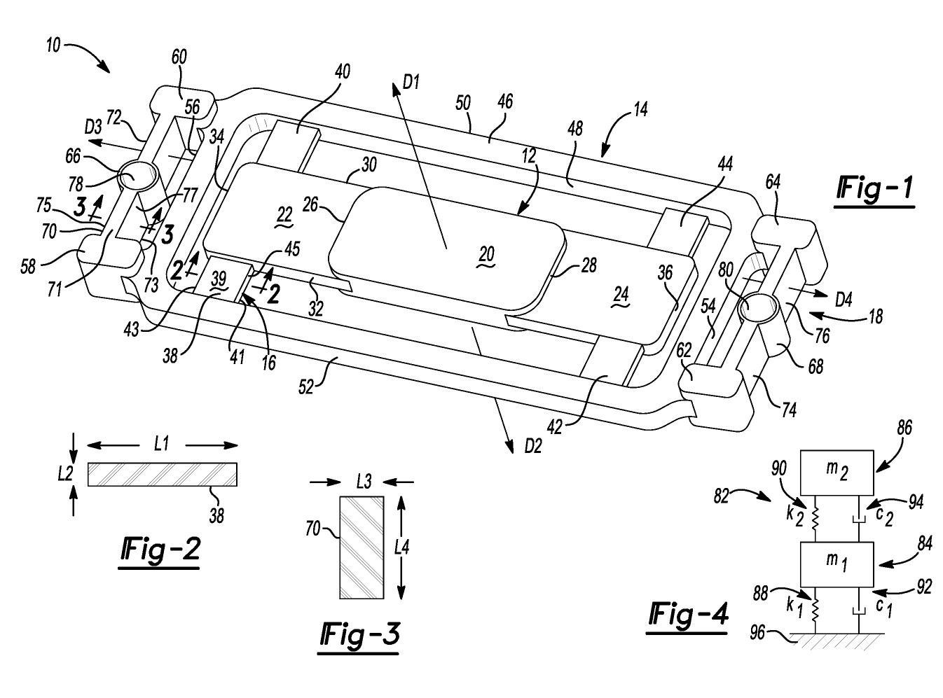

With reference to FIG. 1, a damper 10 is provided. Damper 10 is a dual mass linear mass damper and generally includes a first mass element 12, a second mass element 14, a first set of elastic elements 16, and a second set of elastic elements 18.

First mass element 12 is generally in the form of an elongated rectangular member having a central portion 20 with arms 22, 24 extending from ends 26, 28 thereof. Central portion 20 may extend above and below arms 22, 24, creating an increased thickness for central portion 20 relative to arms 22, 24. First mass element 12 includes first and second sides 30, 32 generally parallel to one another and third and fourth sides 34, 36 generally parallel to one another. First and second sides 30, 32 may be longer than third and fourth sides 34, 36. First set of elastic elements 16 extend between and are coupled to both first mass element 12 and second mass element 14.

First set of elastic elements 16 may include four elastic elements 38, 40, 42, 44. Each of elastic elements 38, 40, 42, 44 may be generally similar to one another. Therefore, only elastic element 38 will be discussed in detail, with the understanding that the disclosure applies equally to elastic elements 40, 42, 44. As seen in FIG. 2, elastic element 38 may have a generally rectangular cross section having a width L1 and a height L2. Width L1 may generally extend parallel to first and second sides 30, 32 of first mass element 12. Width L1 may be greater than height L2. Elastic element 38 may further include upper and lower surfaces 39, 41 and side surfaces 43, 45. Elastic elements 38, 40 may generally extend between arm 22 and second mass element 14 and elastic elements 42, 44 may generally extend between arm 24 and second mass element 14. The method of attaching elastic elements 38, 40, 42, 44 to the connection point may be, but is not limited to, an over molded arrangement, pull/push through retention, glued, locked into place with a retaining feature such as, but not limited to, a dovetail slot, and attached with a retaining feature such as, but not limited to, a bolt or screw.

Second mass element 14 may generally surround sides 30, 32, 34, 36 of first mass element 12. Second mass element 14 may have a generally rectangular body 46 with a generally hollow center portion 48 housing first mass element 12 therein. Second mass element 14 includes first and second sides 50, 52 generally parallel to one another and third and fourth sides 54, 56 generally parallel to one another. First and second sides 50, 52 may be longer than third and fourth sides 54, 56. End members 58, 60, 62, 64 generally extend from third and fourth sides 54, 56. Fastener receiving structures 66, 68 are located between end members 58, 60 and end members 62, 64. Second set of elastic elements 18 extend between and are coupled to both second mass element 14 and fastener receiving structures 66, 68.

Second set of elastic elements 18 may include four elastic elements 70, 72, 74, 76. Each of elastic elements 70, 72, 74, 76 may be generally similar to one another. Therefore, only elastic element 70 will be discussed in detail, with the understanding that the disclosure applies equally to elastic elements 72, 74, 76. As seen in FIG. 3, elastic element 70 may have a generally rectangular cross section having a width L3 and a height L4. Width L3 may extend generally parallel to sides 50, 52 and height L4 may extend generally perpendicular thereto. Height L4 may be greater than width L3. Elastic element 70 may further include upper and lower surfaces 71, 73 and side surfaces 75, 77. Elastic elements 70, 72, 74, 76 may extend between end members 58, 60, 62, 64 and fastener receiving structures 66, 68. The method of attaching elastic elements 70, 72, 74, 76 to the connection point may be, but is not limited to, an over molded arrangement, pull/push through retention, glued, locked into place with a retaining feature such as, but not limited to, a dovetail slot, and attached with a retaining feature such as, but not limited to, a bolt or screw.

While described above as having generally rectangular cross-sections, it is understood that first and second sets of elastic elements may have a variety of different cross sections including, but not limited to, elliptical and circular. Further, it should be understood that elastic elements 38, 40, 42, 44 and elastic elements 70, 72, 74, 76 may have cross sections that are similar or different from one another.

Fastener receiving structures 66, 68 may be rigid cylindrical members preferably made from a metal such as, but not limited to, steel having openings 78, 80 for receiving fasteners therein, or any other appropriate attachment structure, to couple damper 10 to a rigid surface on a structure.

Damper 10 may be used in a variety of applications such as, but not limited to, seats, steering wheels, track bars, and seat tracks. Damper 10 may be used in a number of other applications as well.

In operation, first mass element 12 vibrates in first and second directions D1, D2 and second mass element 14 vibrates in third and fourth directions D3, D4 angularly offset from first and second directions D1, D2. More specifically, in the present example, first mass element 12 vibrates in first and second directions D1, D2, generally opposite one another and perpendicular to upper and lower surfaces 39, 41 of elastic member 38. Second mass element 14 vibrates in third and fourth directions D3, D4, generally opposite one another and perpendicular to side surfaces 75, 77 of elastic element 70. In the present example, upper and lower surfaces 39, 41 of elastic element 38 are shown oriented generally perpendicular to side surfaces 75, 77 of elastic element 70. However, it is understood that a variety of other orientations may be used as well. Preferred orientations include vibrational directions of first mass element 12 relative to second mass element 14 that do not create a canceling effect on the frequency of each. For example, the vibrational direction of first mass element 12 may be in the lateral direction and the vibrational direction of second mass element 14 may be in the vertical direction. While described with respect to two masses, it is understood that more than two masses may be used to target more than two frequencies.

As schematically illustrated in FIG. 4, and discussed above, damper 10 provides a dual mass damper system 82. The system 82 generally includes first and second masses (m1, m2) 84, 86, first and second springs 88, 90 (with stiffness k1, k2), and first and second dashpots 92, 94 (with coefficients of viscous damping c1, c2). The only structure that second mass 86 is coupled to is first mass 84. This coupling is achieved through second spring 90 and second dashpot 94 extending between the first and second masses 84, 86. First mass 84 is further coupled to a structure 96. This coupling is achieved through first spring 88 and first dashpot 92.

Second mass 86 may be comparatively larger than first mass 84 and vibrates at a first natural frequency and direction associated therewith relative to structure 96. First mass 84 has minimal movement relative to structure 96 compared to second mass 86. With regard to the second natural frequency, first and second masses 84, 86 vibrate with generally the same frequency and amplitude. In this arrangement, second spring 90 has minimal or no movement between first and second masses 84, 86 and second dashpot 94 is not working. The spring mass system for the second natural frequency is therefore generally the first and second masses 84, 86 combined (m1+m2) with spring stiffness k1 of first spring 88.

As applied to damper 10, first mass element 12 may generally function as second mass 86 and second mass element 14 may generally function as first mass 84. First set of elastic elements 16 may function as second spring 90 and second dashpot 94. As such, first mass element 12 may vibrate at the first natural frequency with second spring 90 stiffness k2. Second set of elastic elements 18 may function as first spring 88 and first dashpot 92. As such, the combination of first and second mass elements 12, 14 may be generally similar to first and second masses (m1+m2) 84, 86 and may vibrate at the second natural frequency with first spring 88 stiffness k1. Structure 96 may generally be any of the structures noted above regarding the applications for damper 10. Additionally, as previously mentioned, more than two masses may be used to target more than two frequencies.

First and second mass elements 12, 14 may be formed from a variety of materials including, but not limited to, cast iron, cast aluminum, steel, powdered metal, plastic, and impregnated plastic. First and second mass elements may be formed from the same or different materials. First and second sets of elastic elements 16, 18 may be formed from a variety of materials and combinations of materials including, but not limited to, rubber, plastic, silicone, and metal. First and second sets of elastic elements may be formed from the same or different materials from one another.

Damper 10 may be manufactured in a variety of ways including cast or billet masses with over molded elastic elements, powdered metal formed masses with glued elastic elements, and injection molded masses with fastened or retained elastic elements.

What is claimed is:

1. A mass damper system comprising:
a first mass element having a first mass;
a second mass element having a second mass;
a mounting structure;
a first compliant mounting element extending between said first mass element and said mounting structure and coupling said first mass element to said mounting structure for vibration in a first direction relative thereto; and
a second compliant mounting element extending between said first and second mass elements and coupling said second mass element to said first mass element for vibration in a second direction relative thereto, the second direction being angularly offset from the first direction.

2. The mass damper system of claim 1, wherein said second compliant mounting element is configured to inhibit vibration of said second mass element relative to said first mass element in the first direction.

3. The mass damper system of claim 2, wherein said second mass element is mounted only to said first mass element.

4. The mass damper system of claim 2, wherein said second mass element is configured to vibrate in the first direction relative to said mounting structure in phase with said first mass element.

5. The mass damper system of claim 1, wherein said first compliant mounting element is configured to inhibit vibration of said first mass element relative to said second mass element in the second direction.

6. The mass damper system of claim 1, wherein the first direction is generally perpendicular to the second direction.

7. The mass damper system of claim 1, wherein said first compliant mounting element includes first and second elastic elements, said first elastic element extending between a first end of said first mass element and said mounting structure and said second elastic member extending between a second end of said first mass element and said mounting structure.

8. The mass damper system of claim 7, wherein said first and second elastic elements each include cross-sections having a height and a width, said width extending in the first direction and being less than the height.

9. The mass damper system of claim 1, wherein said second compliant mounting element includes third and fourth elastic elements, said third elastic element extending between a first end of said second mass element and said first mass element and said fourth elastic member extending between a second end of said second mass element and said first mass element.

10. The mass damper system of claim 9, wherein said first and second elastic elements each include cross-sections having a height and a width, said height extending in the second direction and being less than the width.

11. The mass damper system of claim 1, wherein said second mass is greater than said first mass.

12. A mass damper system comprising:
a first mass element having a first mass;
a second mass element having a second mass;
a mounting structure;
a first compliant mounting element extending between and coupling said first mass element and said mounting structure to one another; and
a second compliant mounting element extending between and coupling said first and second mass elements to one another, said first and second mass elements forming a combined mass configured to vibrate with one another at a first frequency relative to said mounting structure and said second mass element configured to vibrate relative to said first mass element at a second frequency.

13. The mass damper system of claim 12, wherein said first compliant mounting element is configured to provide vibration of said first and second mass elements in a first direction at the first frequency that is different from a second direction of vibration of said second mass element relative to said first mass element at the second frequency.

14. The mass damper system of claim 13, wherein the first direction is generally perpendicular to the second direction.

15. The mass damper system of claim 12, wherein said first compliant mounting element includes first and second elastic elements, said first elastic element extending between a first end of said first mass element and said mounting structure and said second elastic member extending between a second end of said first mass element and said mounting structure.

16. The mass damper system of claim 12, wherein said second compliant mounting element includes third and fourth elastic elements, said third elastic element extending between a first end of said second mass element and said first mass element and said fourth elastic member extending between a second end of said second mass element and said first mass element.

17. The mass damper system of claim 13, wherein said second mass is greater than said first mass.

18. A mass damper system comprising:
a first mass element having a first mass;
a second mass element having a second mass;
a mounting structure;
first and second elastic elements extending between first and second ends of said first mass element and said mounting structure and elastically coupling said first mass element thereto; and
third and fourth elastic elements extending between first and second ends of said second mass element and said first mass element and elastically coupling said first and second mass elements to one another, wherein said first and second mass elements are configured for vibration with one another in a first direction at a first frequency and said second mass element is configured for vibration relative to said first mass element in a second direction angularly offset from set first direction at a second frequency.

19. The mass damper system of claim 18, wherein said second mass element is free from direct coupling to said mounting structure.

20. The mass damper system of claim 18, wherein said second mass is greater than said first mass.
